(19) United States
(12) Patent Application Publication
(10) Pub. No.: US 2022/0222364 A1
(43) Pub. Date: Jul. 14, 2022

(54) Non-Fungible Token Content Items, Access Controls, and Discovery

(71) Applicant: Facebook Technologies, LLC, Menlo Park, CA (US)

(72) Inventors: Matthew ROBERTS, Menlo Park, CA (US); Adeniyi Emmanuel ABIODUN, San Jose, CA (US)

(21) Appl. No.: 17/708,457

(22) Filed: Mar. 30, 2022

Related U.S. Application Data
(60) Provisional application No. 63/220,630, filed on Jul. 12, 2021.
(60) Provisional application No. 63/220,603, filed on Jul. 12, 2021.
(60) Provisional application No. 63/220,613, filed on Jul. 12, 2021.

(51) Int. Cl. G06F 21/62; H04L 9/00; G06F 16/58

(52) U.S. Cl. CPC G06F 21/6218; G06F 16/5866; H04L 9/50

(57) ABSTRACT

Aspects of the present disclosure are directed to a non-fungible token (NFT) control system that provides for discovery of NFT extras through linking and expanded NFT data structures. Additional aspects of the present disclosure are directed to a creating content item, such as a social media post, that includes tags defined based on at least one non-fungible token (NFT) included in the content item. Further aspects of the present disclosure are directed to a non-fungible token (NFT)-based authorization system that uses verifiable NFT ownership as a basis for granting access to restricted resources.

### CROSS REFERENCE TO RELATED APPLICATIONS

This application claims priority to U.S. Provisional Application Nos. 63/220,603 filed Jul. 12, 2021, entitled “Hybrid Non-Fungible Token Content Items,” 63/220,613 filed Jul. 12, 2021, entitled “Non-Fungible Token Based Access Controls,” and 63/220,630 filed Jul. 12, 2021, entitled “Discovery Through Non-Fungible Token.” Each patent application listed above is incorporated herein by reference in their entireties.

### BACKGROUND

A blockchain is a list of records, each called a block, which can be linked through cryptography. Each block includes a timestamp, a hash of the previous block, and transaction data. The timestamp proves that the transaction data was included when the block was added in order to get its hash. Because each block specifies the block previous to it, the set of blocks make a chain, with each new block reinforcing the set of blocks before it in the chain. Therefore, blockchains are very difficult to modify because data, once added to the blockchain, cannot be altered without altering all subsequent blocks.

Non-Fungible Tokens (NFTs), are blockchain-backed identifiers specifying a unique (digital or real-world) item. Through a distributed ledger, the ownership of these tokens can be tracked and verified. Such tokens can link to a representation of the unique item, e.g., via a traditional URL or a distributed file system such as IPFS. While a variety of blockchain systems support NFTs, common platforms that supports NFT exchange allow for the creation of unique and indivisible NFT tokens. Because these tokens are unique, they can represent items such as art, 3D models, virtual accessories, etc.

Content items, such as documents, social media posts, audio or video files, etc., can be “tagged” in a number of ways. For example, various document editing systems allow content items to be tagged with comments, social media platforms have a variety of mechanism to tag people associated with the post or categorize the post by assigning a “hashtag” to it, object recognition systems can identify objects in an image or video and assign tags for the recognized objects to the image or video, sentiment analysis engines can analyze phrases, tone, expression in audio/video text and tag them with identified sentiments, etc.

### SUMMARY

Aspects of the present disclosure are directed to a non-fungible token (NFT) control system that provides for discovery of NFT extras through linking and expanded NFT data structures. NFT extras can include a variety of information about the NFT such as a history of owners, identifying information for the creator of the NFT, a current offered sale price, past selling prices, contact information for a current owner, links to conversation threads about the NFT, use permissions for the NFT, where the NFT has been used/posted, etc. When a new NFT is created, the NFT control system can specify some NFT extras directly in the NFT (stored on-chain) while specifying other NFT extras as links in the NFT to a location where the extra information is stored (stored off-chain). For example, extras that are unlikely to change between transactions, such as who the NFT creator is and a history of the NFT, can be included as fields in the NFT; while extras that may change, such as a current sale price or NFT use permissions, or are too large to include in the blockchain, such as a messaging thread about the NFT, may have links to a location where these data items are stored. The NFT extras provided by the NFT control system allows for a user interacting with an NFT to discover additional details about the NFT and interact with entities related to the NFT. For example, the user may be able to locate a virtual storefront for the NFT creator to see other NFTs from that creator, join a conversation thread about the NFT, or view a history of ownership of the NFT.

Additional aspects of the present disclosure are directed to a creating content item, such as a social media post, that includes tags defined based on at least one non-fungible token (NFT) included in the content item. In various implementations, the tags define multiple NFTs included in the content item and/or role attributions for multiple individuals, specified in the one or more NFTs, as having contributed to creation of the content item. For example, a user can specify one or more NFTs for a social media post, and an NFT attribution system can tag each of the included NFTs in the social media post according to the parts of the post to which each NFT corresponds. As a further example, one or more of these NFTs can define roles of one or more users who contributed to the content in the social media post, such as a graphic designer, a marketing manager, a content reviewer, etc., and the tags on the social media post can further specify these users with their associated roles.

Further aspects of the present disclosure are directed to a non-fungible token (NFT)-based authorization system that uses verifiable NFT ownership as a basis for granting access to restricted resources. A restricted resource (e.g., a restricted content item, a restricted action, restricted portal, etc.) can be associated with an access control list specifying entities allowed to access that resource. Some entries on such an access control list can identify an NFT, indicating that the NFT can act as a key to access the restricted resource. In one case, when a restricted resource is requested, a NFT wallet can be provided, allowing the NFT-based authorization system to verify the required NFT is in the NFT wallet, and if so, grant access to the restricted resource. In another case, when a restricted resource is requested, a user identity can be verified, allowing the NFT-based authorization system to check the NFT blockchain to ascertain whether the required NFT is owned by the identified user. In some cases, the NFT-based authorization system can implement a public/private key cryptography system, where content of an NFT can serve as a public key for the user specified in a blockchain as the owner of the NFT.

### BRIEF DESCRIPTION OF THE DRAWINGS

FIG. 1A is an example illustrating NFT transactions in a blockchain.

FIG. 1B is an example illustrating a data structure of NFT extras, as off-chain NFT extras and on-chain NFT extras.

FIG. 2 is a flow diagram illustrating a process used in some implementations for creating and updating an NFT with NFT extras.

FIG. 3A is an example of a social media post including multiple NFTs and associated tags.

FIG. 3B is an example of a social media post including an NFT with multiple defined creators with different roles, each having an associated tag.

FIG. 4 is a flow diagram illustrating a process used in some implementations for creating a content item with one or more NFTs and corresponding tags.

FIG. 5A is an example of a user interface for supplying an NFT wallet as a credential for access to a restricted file.

FIG. 5B is an example of a user interface providing a notification that access to the restricted file has been granted based on an NFT in the supplied NFT wallet.

FIG. 6 is a flow diagram illustrating a process used in some implementations for authorizing access to a restricted resource based on NFT ownership.

FIG. 7 is a block diagram illustrating an overview of devices on which some implementations of the present technology can operate.

FIG. 8 is a block diagram illustrating an overview of an environment in which some implementations of the present technology can operate.

### DESCRIPTION

An NFT control system can include a schema for NFT extras that can optionally be specified for each NFT. This schema can define NFT extra types and define whether each is stored on-chain (e.g., as part of the NFT) or off-chain (e.g., as data linked to from the NFT). This schema can include, for each NFT extra, a name, a type, optionally a description, and data (either as an on-chain data object or as a link to an off-chain data object). Data stored on-chain may be limited by a maximum data size. Links to off-chain data objects can be in the form of a URI, an IPFS address, or another globally unique identifier, and can link to any form of computer addressable content item of various sizes.

Examples of on-chain NFT extras can include: an ID for a creator of the NFT; a list of transactions of the NFT (which may have context specifics such as a natural language description of a sale context, terms of a transaction, identifier of a transaction mediator—e.g., auction house); lengths of time an NFT has been held by various individuals, a link to an owner contact—e.g., allowing for questions to be posed to the NFT owner/seller; etc. Examples of off-chain NFT extras can include: a link to a digital storefront of a the creator of the NFT; associations to other NFTs related to this NFT (e.g., from the same creator, visually similar, viewed by the same users or user types, often used together on social media, etc.); a current offer price for selling the NFT; a link to a conversation thread about the NFT or in which the NFT was used; a set of permissions, attribution requirements, or license terms for others to use the NFT; indications of where the NFT has been posted to social media sites or used in other media; etc. While various NFT extras are described herein as being either on-chain or off-chain, in various implementations, each NFT extra type can be created as either on-chain or off-chain.

The ability to include a providence of an NFT, such as who has previously owned it and the conversation surrounding it, can greatly increase the NFT value. Furthermore, the ability to allow NFT creators, owners, and buyers to identify one another, access sale information, and link to additional sale items, directly from an NFT, increases the marketplace for NFTs and the overall value of the NFT economy.

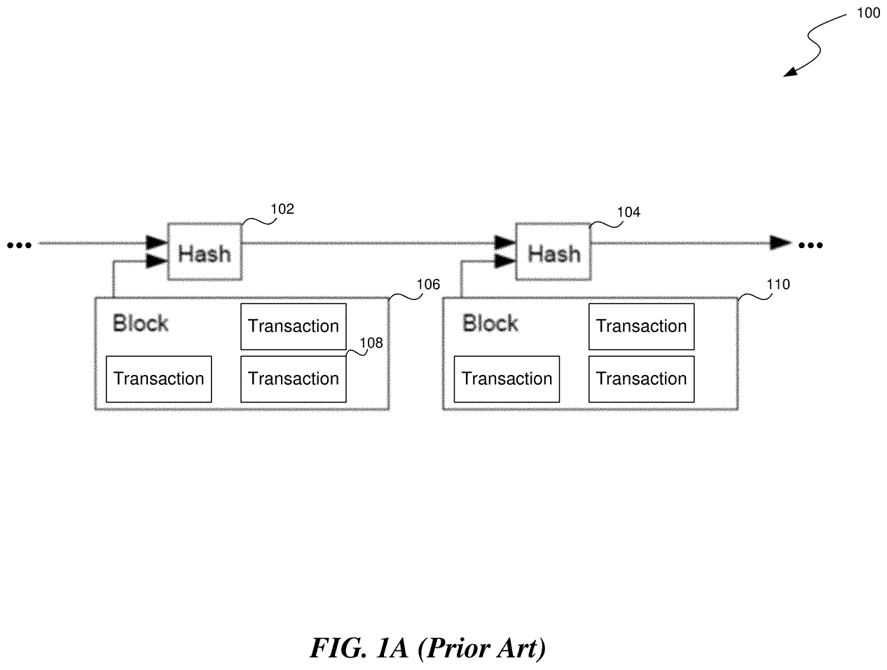

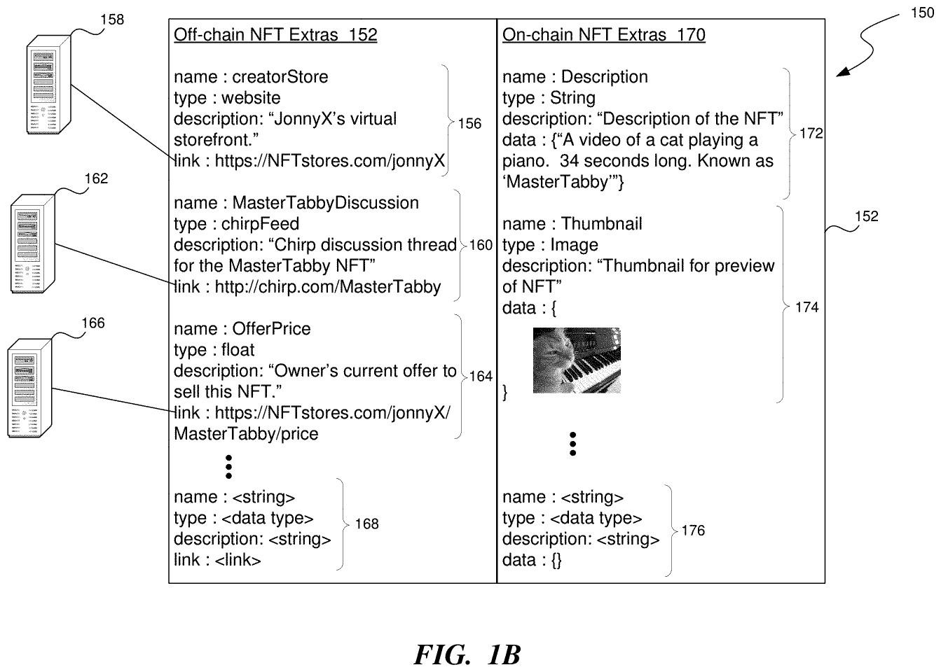

FIG. 1A is an example 100 illustrating NFT transactions in a blockchain. Example 100 includes a set of blocks (e.g., blocks 106 and 110) each including a set of transactions (e.g., NFT transfer, minting, and burning activities), such as transaction 108. The blocks are linked by a series of hash values (e.g., hash values 102 and 104). Each has value combines a hash of the transactions in the block and of the hash of the previous block in the chain. Thus, hash 104 is a hash of both the hash 102 and the transactions in block 110. In this manner, each hash in the chain is dependent on all the data in the previous blocks in the chain, making undetected modification of earlier blocks in the chain very difficult.

FIG. 1B is an example 150 illustrating a data structure of NFT extras 152, as off-chain NFT extras 154 on-chain NFT extras 170. Though separated in FIG. 1B as on-chain and off-chain for clarity, in some implementations, these NFT extras can co-exist as interspersed records of the NFT. Off-chain NFT extras 154, in example 150, include off-chain NFT extras 156, 160, and 164. As illustrated by the off-chain NFT extras template 168, each off-chain NFT extra record can include a name, a data type the off-chain NFT extra links to, a description, and a link. In various implementations, off-chain NFT extras can include additional fields (e.g., ID, data size, etc.) or fewer fields (e.g., omitting the type or description fields).

Off-chain NFT extra 156 is for providing a link to a virtual storefront of the creator of the NFT, allowing other users who see the NFT to visit the creator's virtual storefront to purchase other NFTs. Off-chain NFT extra 156 includes a name “creatorStore;” a type specifying that this links to a website; a description: “JonnyX's virtual storefront;” and the link to the virtual storefront https://NFTstores.com/jonnyX, hosted on computing system 158.

Off-chain NFT extra 160 is for providing a link to a discussion of the NFT on a third-party platform called Chirp, allowing other users who see the NFT easily join the conversation. Off-chain NFT extra 160 includes a name “MasterTabbyDiscussion;” a type specifying that this links to a feed on the Chirp platform; a description: “Chirp discussion thread for the MasterTabby NFT;” and the link to the Chirp discussion http://chirp.com/MasterTabby, hosted on the Chirp computing system 162.

Off-chain NFT extra 164 is for providing a link to currently offered sale price of the NFT, allowing other users who see the NFT quickly determine if they would like to buy it. Off-chain NFT extra 164 includes a name “OfferPrice;” a type specifying that this links to a floating point number; a description: “Owner's current offer to sell this NFT;” and the link to the currently offered sale price https://NFTstores.com/jonnyX/MasterTabby/price, hosted on computing system 166.

On-chain NFT extras 170, in example 150, include on-chain NFT extras 172 and 174. As illustrated by the on-chain NFT extras template 176, each on-chain NFT extra record can include a name, a data type for the data stored in the NFT, a description, and the actual data of the on-chain NFT extra. In various implementations, on-chain NFT extras can include additional fields (e.g., ID, data size, etc.) or fewer fields (e.g., omitting the type or description fields).

On-chain NFT extra 172 provides a description of the content item the NFT is for, giving users who access the NFT a textual description of the content item. On-chain NFT extra 172 includes a name “Description;” a type specifying that this data item is a string; a description: “Description of the NFT;” and the data—a string describing the NFT: “A video of a cat playing a piano. 34 seconds long. Known as ‘MasterTabby.’”

On-chain NFT extra 174 provides an image that can be used as a thumbnail of the content item the NFT is for, providing a way for the NFT to be represented consistently as a thumbnail across platforms. On-chain NFT extra 174 includes a name “Thumbnail;” a type specifying that this data item is an image; a description: “Thumbnail for preview of NFT;” and the data—a thumbnail image of the NFT content item.

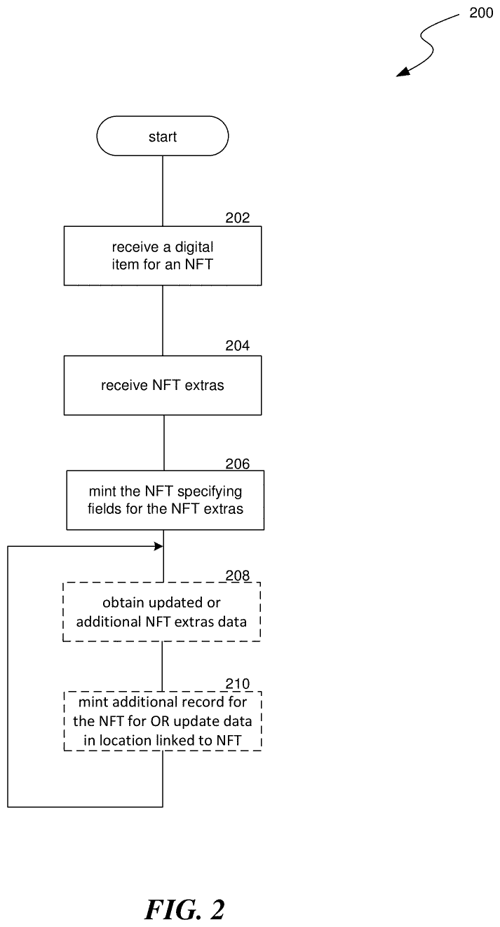

FIG. 2 is a flow diagram illustrating a process 200 used in some implementations for creating and updating an NFT with NFT extras. In some implementations, process 200 can be implemented on a server system providing an interface for creation and updating of an NFT with NFT extras. In other implementations, process 200 can be performed on a client device, e.g., as s node in a blockchain system. In some implementations, process 200 can be initiated in response to a user command (e.g., accessing a website, starting an application or widget, etc.) to create or update an NFT.

At block 202, process 200 can receive a digital item for minting a new NFT. The digital item can be any referenceable computerized object, such as an image, video, 3D model, file, social media post, audio, etc. In some implementations, the item can be a reference to a real-world item, such as an address for property, a serial number, a vehicle identification number (VIN), or another object ID.

At block 204, process 200 can receive one or more NFT extras to include with the NFT. In various implementations, the NFT extras can include particular data items to be stored on-chain and/or links to data items stored off-chain. In some implementations, all NFT extras are stored off-chain, with pointers to the NFT extra data stored on-chain in the NFT. In addition to the data or link, each NFT extra can specify an identifier (e.g., field name by which the NFT extra can be referenced). In various implementations, an NFT extra can specify additional properties such as a natural language description, a platform or source for off-chain NFT extras, a type of the data in the NFT extra or that the NFT extra links to, etc. In some cases, the NFT extra can include an extensible properties field, allowing the provider to define additional properties for the NFT extra. Examples of on-chain NFT extras can include: an ID for a creator of the NFT; a list of transactions of the NFT (which may have context specifics such as a natural language description of a sale context, terms of a transaction, identifier of a transaction mediator—e.g., auction house); lengths of time an NFT has been held by various individuals, a link to an owner contact—e.g., allowing for questions to be posed to the NFT owner/seller; etc. Examples of off-chain NFT extras can include: a link to a digital storefront of a the creator of the NFT; associations to other NFTs related to this NFT (e.g., from the same creator, visually similar, viewed by the same users or user types, often used together on social media, etc.); a current offer price for selling the NFT; a link to a conversation thread about the NFT or in which the NFT was used; a set of permissions, attribution requirements, or license terms for others to use the NFT; indications of where the NFT has been posted to social media sites or used in other media; etc. While various NFT extras are described herein as being either on-chain or off-chain, in various implementations, each NFT extra type can be created as either on-chain or off-chain.

At block 206, process 200 can mint the NFT for the digital item received at block 202, specifying fields for the NFT extras received at block 204. Once the link to the item and NFT extras are established, the minting of the NFT can include adding it to the blockchain, such as by broadcasting the minting transaction to miner nodes so that it can be recorded in the longest branch of the blockchain.

While any block of process 200 can be removed or rearranged in various implementations, blocks 208 and 210 are shown in dashed lines to indicate there are specific instances where blocks 208 and 210 are skipped and process 200 ends. For example, in some cases the NFT extra data is not updated or is updated by another system, in which case process 200 can end after block 206.

At block 208, process 200 can obtain updated or additional NFT extras data. As discussed in relation to block 204, a variety of data types can be specified in NFT extras, and in some cases the associated data will need to be updated or new fields will need to be added as circumstances change. For example, an NFT sale price may change or a new field linking to a newly created discussion of the NFT may need to be added. The data or link for the NFT extras can be obtained along with other properties of the NFT extras, such as the identifier, type, or description.

At block 210, process 200 can update the NFT extras based on the data received at block 208. In some cases, this can include updating data stored off-chain, e.g., causing the data at the destination linked to from the NFT extra to be updated. In other cases, this can include updating data stored on-chain. Where the NFT extra was part of the hash of the block containing the NFT, used by subsequent blocks on the blockchain, the updating data stored on-chain or adding new ones can include minting a new record into the blockchain with the new or updated information. In some implementations, certain NFT extra data may not be included in the hash of a blockchain block, in which case it can be updated without having to create a new block. As new NFT extra updates are provided, process 200 can return to blocks 208 and 210 to again update the NFT extra fields.

An NFT attribution system can incorporate one or more NFTs into a content item and tag the content item with attributes from the one or more NFTs. In some implementations, multiple NFTs can be included in the same content item, and the tags can specify each NFT, which may link to an area in the content item where each NFT exists. As an example, a social media post can be created with three NFTs, arranged in a grid. The NFT attribution system can include tags on the social media post indicating each of the included NFTs. In various implementations, each NFT tag may be placed relative to the portion of the post containing the corresponding NFT or may otherwise link to the portion, e.g., by highlighting the portion when the NFT tag is selected.

In further implementations, one or more NFTs can be included in a content item, where the one or more NFTs specify multiple originators, and the tags can specify each originator for the content item. In some cases, the NFTs can further indicate roles of each originator, which can be indicated in the corresponding tags. As an example, a video file may include four NFTs, each indicating a user and a role in relation to the video. The four NFTs can include a director role, a sound manager role, an actor role, and a lighting role. These NFTs can be tagged in the video as meta-data allocating the indicated roles to each corresponding user.

In some implementations, social media posts can be the content items that include NFTs, and the attributions from the NFT attribution system can be stored as edges between the content item node and the included NFT node in a social graph. This can allow linking between social networking system objects (e.g., users, posts, events, minutia, etc.) according to shared NFTs.

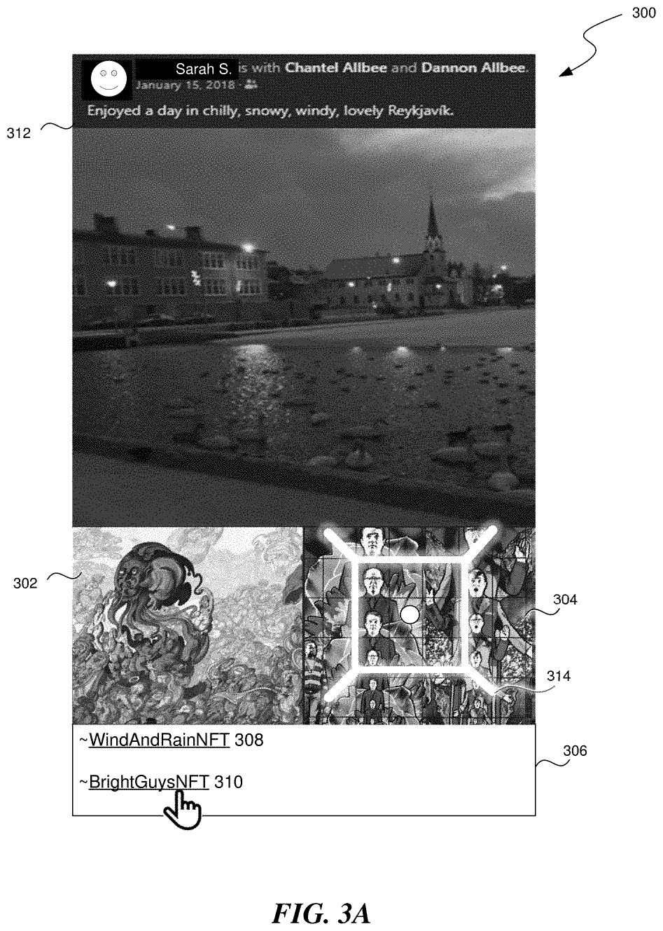

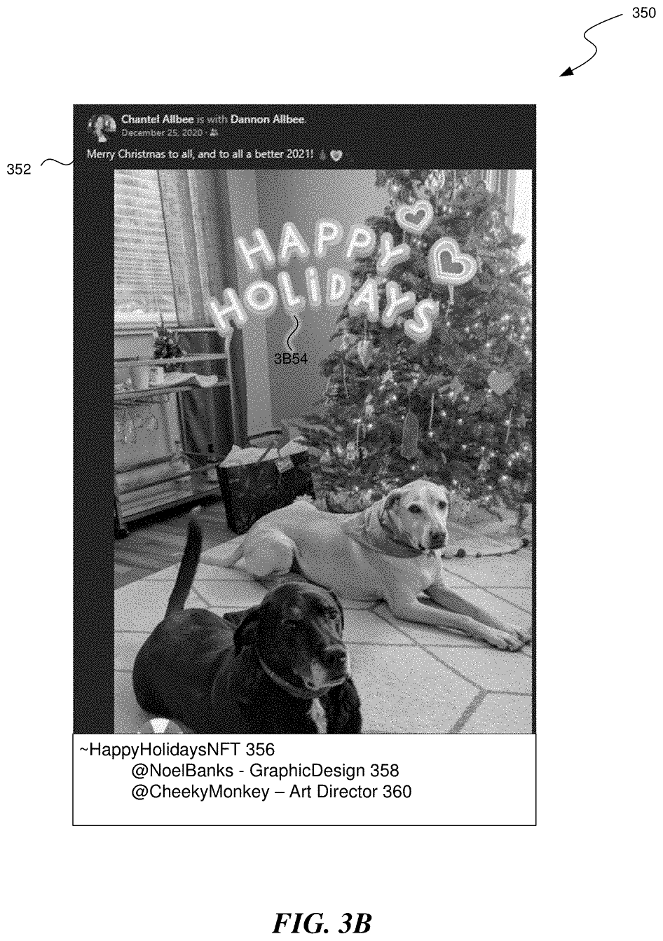

FIG. 3A is an example 300 of a social media post 312 including multiple NFTs and associated tags. In example 300, a user has posted to a social media site including two NFTs 302 and 304, based on photos of artwork she has taken. When the post was created, the NFT attribution system added tags 308 and 310 to the social media post with ˜ identifiers showing these as tags for NFTs, followed by a textual title extracted from meta-data of the NFT. Each tag 308 and 310 is associated with an area in the post where the content of the NFT is displayed. When a user moves a cursor over one of the tags, tag 310 in this example, an icon 314 appears in the post indicating which area in the post has the NFT.

FIG. 3B is an example 350 of a social media post 352 including an NFT 354 with multiple defined creators with different roles, each having an associated tag. In example 350, the “Happy Holidays” NFT 354 has been included as an overlay on a user's photo. This NFT was created by a team including a graphic designer and an art director. The NFT includes meta-data specifying these roles and a corresponding user identifier for each. Upon creation of the social media post with this NFT, the NFT attribution system added tag 356 to the social media post with the ˜ identifier showing this is a tag for an NFT. Extracting the roles and corresponding user identifiers from the NFT, the NFT attribution system further creates sub-tags 358 and 360, signifying these roles and the users in each for this NFT 354.

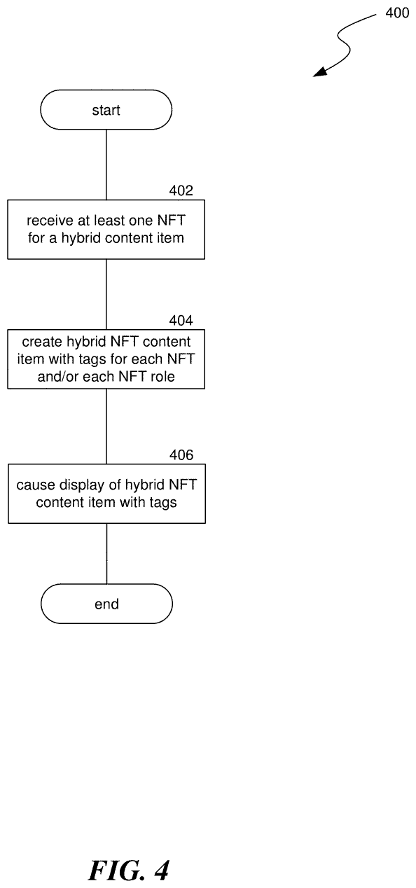

FIG. 4 is a flow diagram illustrating a process 400 used in some implementations for creating a content item with one or more NFTs and corresponding tags. In various implementations, process 400 can be performed on a server system, such as for a social media platform, online document processing or storage system, etc., or on a client device, such as that of a content item creator. Process 400 can be initiated when a user adds an NFT to a content item or when the user submits the content item with the NFT to a platform server.

At block 402, process 400 can receive at least one NFT for a hybrid content item (i.e., a content item that includes more than a single NFT—such as multiple NFTs and/or an NFT and other content items). The NFT can be received in conjunction with a container content item, such as a document, social media post, image, video, audio file, 3D model, etc.

At block 404, process 400 can create the hybrid content item with tags for each NFT and/or each NFT role. For example, process 400 can extract meta-data from each NFT, such as a title or owner, and use the meta-data to create a tag on the content item containing that NFT. In some cases, the tag can be associated with a portion of the content item where the NFT is located. For example, a tag can be added as an overlay on a social media post, image, or video; as a comment on a section of a document; as a pointer on a 3D model; etc. In some cases, each NFT can specify one or more roles for different “contributors” involved in the creation of the content item—e.g., illustrator, editor, director, etc. The tags on the content item may indicate the various contributors and/or the roles each contributor played in the content item creation. In some implementations where portions of the content item are visually attributable to particular contributors, the tags may be associated with the portion of the content item the contributor created.

At block 406, process 400 can cause display of the hybrid NFT content item with the tags added at block 404. For example, process 400 can serve a social media site including the content item with the tags; can open a document showing the tag comments; can play a video, audio file, or show an image with associated tags, etc. In some implementations, the shown tags can be actionable, such as to access a details page for the NFT, go to a virtual storefront of an originator of the NFT, show where in the content item the NFT relates to, show a transaction history for the NFT, load an interface for buying the NFT, etc. Process 400 can then end.

An NFT-based authorization system can use NFT ownership as a basis for granting access to restricted resources. Such NFT ownership is verifiable through a blockchain system where a distributed ledger can virtually guarantee that the identifier of a user specified as the owner of the NFT has not been altered. In some cases, NFTs can be securely transferred between users, allowing transfer of the associated access rights without the need for mediation or approval by a central system. Further, in some systems, the access rights can remain quasi-anonymous, as proof of NFT ownership can be provided (e.g., through provisioning of a NFT wallet) without having to provide other personally identifying information.

Any type of computer resource can be restricted with the NFT-based authorization system, such as individual content items, actions that require computing system approval, a restricted portal such as a website or application, etc. The NFT-based authorization system can control restricted resources by maintaining associations between particular NFTs and a restricted resource—such associations are referred to herein as an “access control list.” In some cases, the access control list can specify various types of access to a restricted resource that a particular NFT provides. For example, a file in a computing system can have separate rights for reading, writing, and executing the file, and an NFT can be associated with one or a combination of these rights. Thus, the NFT can act as a key to access the restricted resource and/or take particular actions with regard to the restricted resource. In one case, when a restricted resource is requested, a NFT wallet can be provided, allowing the NFT-based authorization system to verify the required NFT is in the NFT wallet, and if so, grant access to the restricted resource. In another case, when a restricted resource is requested, a verified user identifier can be provided, allowing the NFT-based authorization system to check the NFT blockchain to verify the required NFT is owned by the user with the supplied user identifier.

In some cases, the NFT-based authorization system can implement a public/private key cryptography system, where the content of an NFT can serve as a public key for the user specified in a blockchain as the owner of the NFT. In public/private key cryptography, content can be encrypted with a recipient's public key but cannot be decrypted without a private key known only to the recipient. The reverse process can be used to add a signature to a content item, e.g., encrypting a portion with the private key—presumably only know to the private key owner—which can be verified with the matching public key. Public keys are typically held by a trusted third party (e.g., key authority). However, a potential vulnerability public/private key cryptography is a “man-in-the-middle” attack where the communication of public keys is intercepted by a third party and is then modified to provide different public keys. However, the NFT-based authorization system can use a blockchain system where the NFT-based authorization system content is a user's public key, allowing the owner of that public key to be verified.

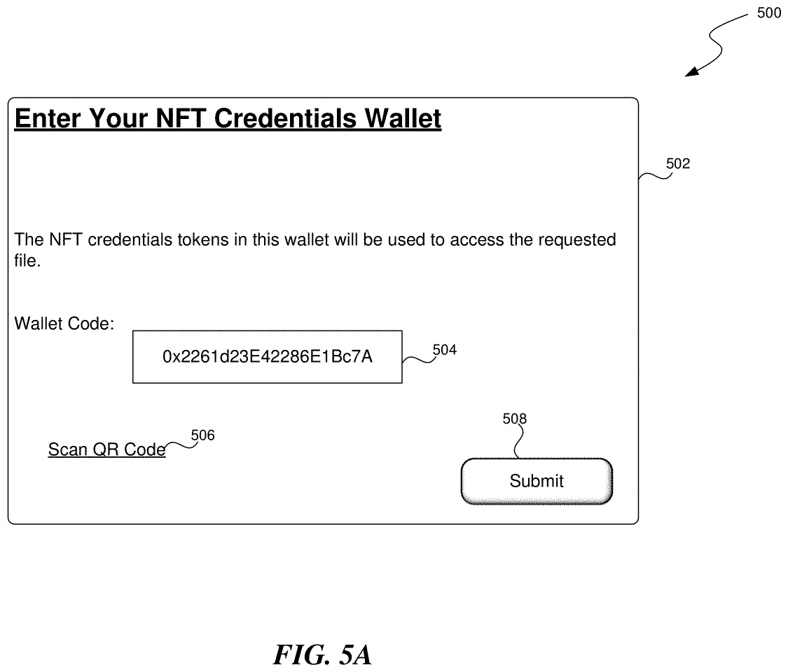

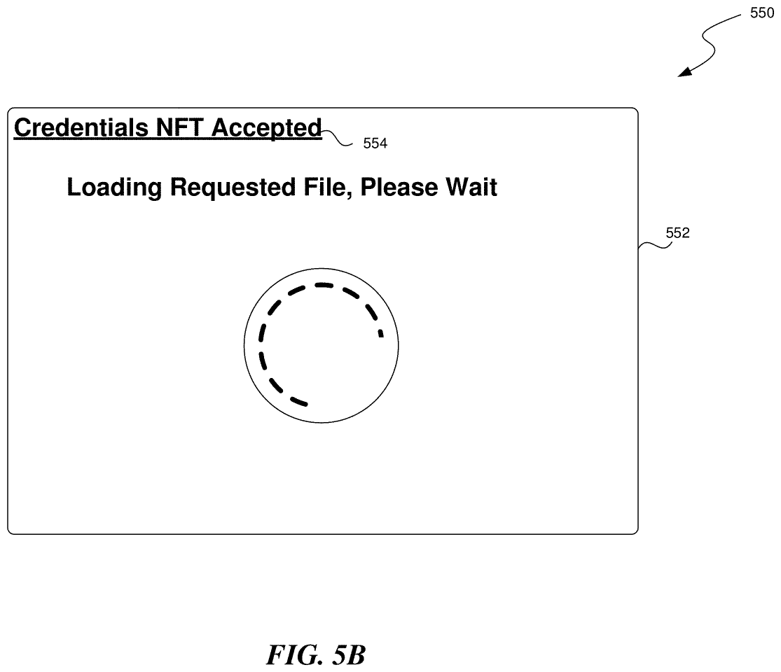

FIG. 5A is an example 500 of a user interface for supplying an NFT wallet as a credential for access to a restricted file. Example 500 includes a modal dialog 502 requesting that the user provide a code for her digital wallet containing an NFT mapped to the access for a restricted file the user is requesting. In input 504, the user has entered the code for her walled to prove she has rights for the requested access. Modal dialog 502 also includes an option 506 to scan a QR code provided by the NFT walled, instead of having to copy and paste or manually enter the wallet code. Once the wallet code has been provided, the user can click submit button 508 to have the NFT-based authorization system check that the indicated wallet has the required NFT.

FIG. 5B is an example 550 of a user interface providing a notification that access to the restricted file has been granted based on an NFT in the supplied NFT wallet. In example 550, the NFT-based authorization system has verified that the wallet indicated by the user includes an NFT specified on an access control list for the file. Thus, example 550 shows a modal dialog 552 with a message 554 indicating that the NFT credentials were accepted and the requested file is being provided.

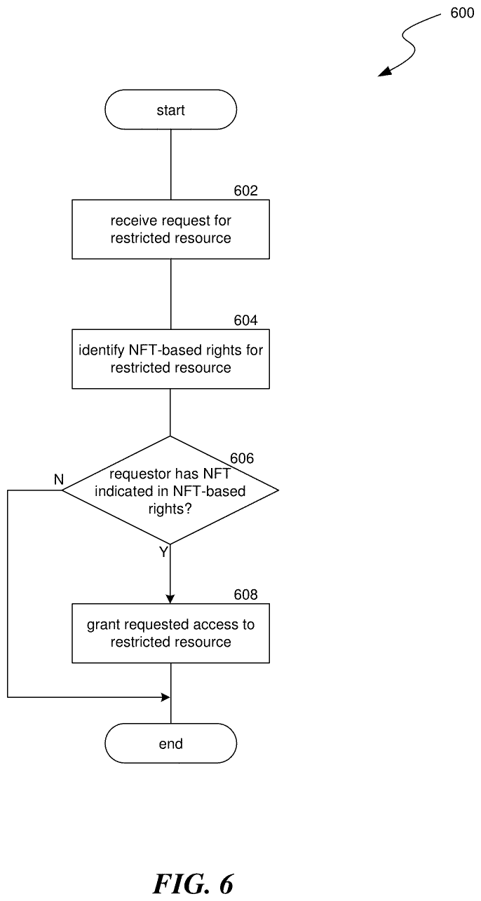

FIG. 6 is a flow diagram illustrating a process 600 used in some implementations for authorizing access to a restricted resource based on NFT ownership. In various implementations, process 600 can be performed on a server system mediating restricted resources or on a local system (e.g., an operating system in control of resource management).

At block 602, process 600 can receive a request for a restricted resource. For example, the request can come in the form of a request to access a website, an operation to open a file, a request to take an action (e.g., move or copy data, execute an application, stop a running process, etc.), an operation to access a database, etc. As used herein, a “restricted resource” can be any content item or action mediated by a computing system. A resource can be restricted though an access control list, as discussed above.

At block 604, process 600 can identify NFT-based rights for the restricted resource requested at block 600. This can include checking that an access control list exists for the restricted resource and that the access control list specifies that access to the restricted resource can be granted based on NFT ownership. Such an NFT used for access control is referred to herein as a “credential NFT.” In some cases, the access control list can specify access rights for different types of access to the restricted resource. For example, a restricted file can include a traditional read, write, execute privileges model, and different credential NFTs can be specified for each of these rights or for a combination of them. Other privilege models can divide access rights in other ways, such as for the ability to log into a system as a regular user versus as an administrator.

At block 606, process 600 can determine whether the requestor has ownership of a credential NFT that, according to the access control list, provides the access requested. In some implementations, this can be accomplished by receiving access to a digital NFT wallet, which process 600 can check to verify that it contains the required credential NFT. In other implementations, proof of an identify can be provided and process 600 can check the NFT blockchain to verify that ownership of the credential NFT matches the identity. For example, the requestor can provide a piece of content signed with a private key, which a public key for the request (which in some cases may be stored in the credential NFT needed for access) can be used to verify the requestor's identity and, if that identity matches the ownership information for the NFT, ownership of the credential NFT. If the requestor does not prove ownership of the credential NFT, process 600 can end without allowing the requested access, which may include responding to the request with an “access denied” message. If the requestor proves ownership of the credential NFT that provides the access requested, process 600 can continue to block 608.

At block 608, process 600 can, in response to the determination that the requestor has ownership of the credential NFT, allow access to restricted resource. For example, process 600 can allow the user to open a requested file, allow the user to executed a requested application, serve a requested website, allow a requested database action, etc. Thus, process 600 can grant the type of access, to the requested resource, mapped in the access control list to the credential NFT. Process 600 can then end.

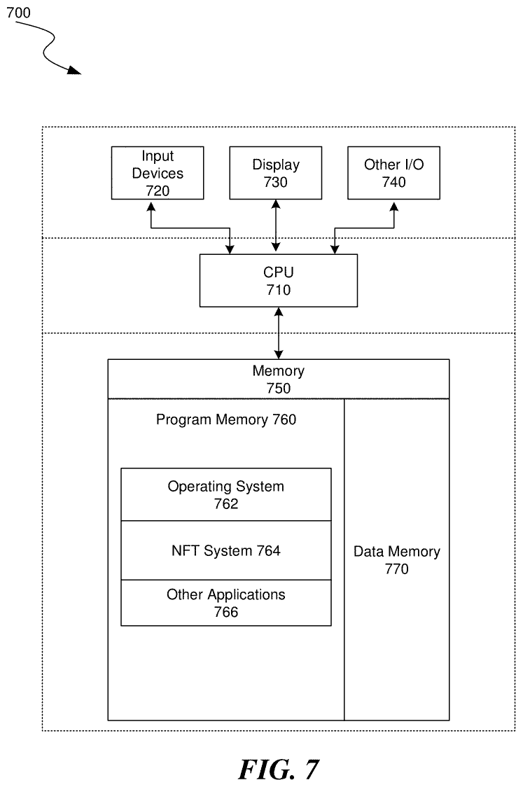

FIG. 7 is a block diagram illustrating an overview of devices on which some implementations of the disclosed technology can operate. The devices can comprise hardware components of a first instance of device 700 that provides for discovery of NFT extras through linking and expanded NFT data structures. The devices can comprise hardware components of a second instance of device 700 that can incorporate one or more NFTs into a content item and tag the content item with attributes from the one or more NFTs. The devices can comprise hardware components of a third instance of device 700 that use NFT ownership as a basis for granting access to restricted resources. Instances of device 700 can include one or more input devices 720 that provide input to the Processor(s) 710 (e.g., CPU(s), GPU(s), HPU(s), etc.), notifying it of actions. The actions can be mediated by a hardware controller that interprets the signals received from the input device and communicates the information to the processors 710 using a communication protocol. Input devices 720 include, for example, a mouse, a keyboard, a touchscreen, an infrared sensor, a touchpad, a wearable input device, a camera- or image-based input device, a microphone, or other user input devices.

Processors 710 can be a single processing unit or multiple processing units in a device or distributed across multiple devices. Processors 710 can be coupled to other hardware devices, for example, with the use of a bus, such as a PCI bus or SCSI bus. The processors 710 can communicate with a hardware controller for devices, such as for a display 730. Display 730 can be used to display text and graphics. In some implementations, display 730 provides graphical and textual visual feedback to a user. In some implementations, display 730 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 740 can also be coupled to the processor, such as a network card, video card, audio card, USB, firewire or other external device, camera, printer, speakers, CD-ROM drive, DVD drive, disk drive, or Blu-Ray device.

In some implementations, the device 700 also includes a communication device capable of communicating wirelessly or wire-based with a network node. The communication device can communicate with another device or a server through a network using, for example, TCP/IP protocols. Device 700 can utilize the communication device to distribute operations across multiple network devices.

The processors 710 can have access to a memory 750 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 750 can include program memory 760 that stores programs and software, such as an operating system 762, NFT System 764, and other application programs 766. Memory 750 can also include data memory 770, e.g., NFT items, NFT extras data, blockchain transaction details, NFT meta-data, hybrid content items, access control lists, restricted resources, public key authority identifiers, configuration data, settings, user options or preferences, etc., which can be provided to the program memory 760 or any element of the device 700.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

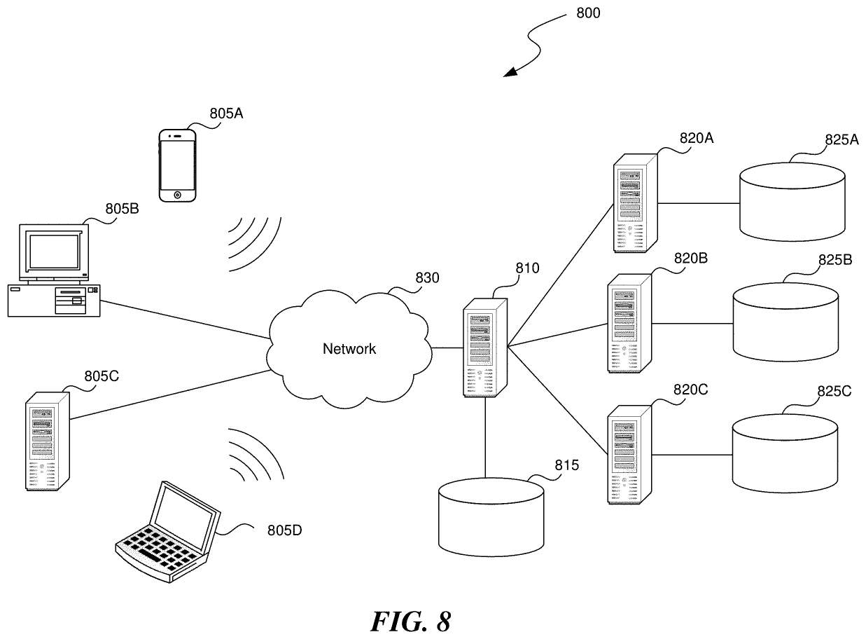

FIG. 8 is a block diagram illustrating an overview of an environment 800 in which some implementations of the disclosed technology can operate. Environment 800 can include one or more client computing devices 805A-D, examples of which can include device 700. Client computing devices 805 can operate in a networked environment using logical connections through network 830 to one or more remote computers, such as a server computing device.

In some implementations, server 810 can be an edge server which receives client requests and coordinates fulfillment of those requests through other servers, such as servers 820A-C. Server computing devices 810 and 820 can comprise computing systems, such as device 700. Though each server computing device 810 and 820 is displayed logically as a single server, server computing devices can each be a distributed computing environment encompassing multiple computing devices located at the same or at geographically disparate physical locations. In some implementations, each server 820 corresponds to a group of servers.

Client computing devices 805 and server computing devices 810 and 820 can each act as a server or client to other server/client devices. Server 810 can connect to a database 815. Servers 820A-C can each connect to a corresponding database 825A-C. As discussed above, each server 820 can correspond to a group of servers, and each of these servers can share a database or can have their own database. Databases 815 and 825 can warehouse (e.g., store) information. Though databases 815 and 825 are displayed logically as single units, databases 815 and 825 can each be a distributed computing environment encompassing multiple computing devices, can be located within their corresponding server, or can be located at the same or at geographically disparate physical locations.

Network 830 can be a local area network (LAN) or a wide area network (WAN), but can also be other wired or wireless networks. Network 830 may be the Internet or some other public or private network. Client computing devices 805 can be connected to network 830 through a network interface, such as by wired or wireless communication. While the connections between server 810 and servers 820 are shown as separate connections, these connections can be any kind of local, wide area, wired, or wireless network, including network 830 or a separate public or private network.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following. A computer-readable storage medium storing instructions that, when executed by a computing system, cause the computing system to perform a process comprising: receiving one or more NFTs for a hybrid content item, wherein the one or more NFTs specify multiple roles in relation to the NFT and/or the hybrid content item; creating the hybrid content item with tags for each role specified in the one or more NFTs; and causing display of the hybrid content item including the tags. A memory for storing data for access by an application program being executed on a NFT control system, comprising: one or more data structures stored in the memory, the data structures including information used by the application program and including: a plurality of NFT extras data objects, stored in the memory, wherein each particular NFT extras data object, of the NFT extras data objects, is specified in relation to an NFT and defining at least: a name for the particular NFT extras data object, a type for the particular NFT extras data object, and a data object of the type or a link to a data object of the type.

I/We claim:

1. A method for creating an NFT with NFT extras, the method comprising:
receiving a digital item for an NFT;
receiving NFT extras as additional data related to the NFT or the digital item; and
minting the NFT specifying fields for the NFT extras.

2. A method for adding tags to a hybrid content item with attributes from multiple NFTs, the method comprising:
receiving the multiple NFTs for the hybrid content item;
creating the hybrid content item with a tag for each of the multiple NFTs; and
causing display of the hybrid content item including the tags.

3. A method for granting access to a restricted resource based on NFT ownership, the method comprising:
receiving a request for a restricted resource from a requestor;
identifying NFT-based rights for the restricted resource;
determining ownership of a credential NFT in relation to the requestor;
determining that the credential NFT is specified on an access control list as providing rights for the restricted resource and, in response:
granting the request for the restricted resource.
